(19) United States
(12) Patent Application Publication
(10) Pub. No.: US 2025/0065312 A1
(43) Pub. Date: Feb. 27, 2025

(54) MOLECULAR SIEVE, BORON ITQ-21, ITS SYNTHESIS AND USE

(71) Applicant: Chevron U.S.A. Inc., San Ramon, CA (US)

(72) Inventors: Stacey I. Zones, San Francisco, CA (US); Cong-Yan Chen, Kensington, CA (US)

(73) Assignee: Chevron U.S.A. Inc., San Ramon, CA (US)

(21) Appl. No.: 18/810,971

(22) Filed: Aug. 21, 2024

Related U.S. Application Data
(60) Provisional application No. 63/578,493, filed on Aug. 24, 2023.

(51) Int. Cl. B01J 29/04; B01J 37/00; B01J 37/03; B01J 37/04; B01J 37/06; B01J 37/08; B01J 37/20; C01B 39/48; C10G 35/06

(52) U.S. Cl. CPC B01J 29/047; B01J 37/0018; B01J 37/009; B01J 37/031; B01J 37/04; B01J 37/06; B01J 37/08; B01J 37/20; C01B 39/48; C10G 35/065; B01J 2229/183; C01P 2002/72

(57) ABSTRACT

A novel synthetic crystalline molecular sieve material, designated boron ITQ-21, is provided. The boron ITQ-21 can be synthesized using an N,N-diethyl-5,8-dimethyl-2-azonium bicyclo [3.2.2] nonane cation as a structure directing agent. The boron ITQ-21 may be used in organic compound conversion reactions and/or sorptive processes.

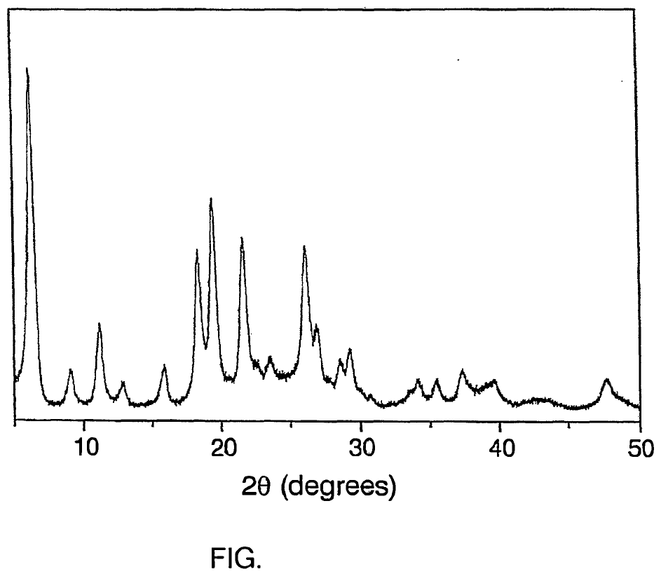

### CROSS REFERENCE TO RELATED APPLICATIONS

This application claims priority to U.S. Provisional Application Ser. No. 63/578,493 filed Aug. 24, 2023, the complete disclosure of which is incorporated herein by reference in its entirety.

### FIELD

This disclosure relates to a novel synthetic crystalline germanosilicate molecular sieve designated boron ITQ-21, and its synthesis.

### BACKGROUND

Molecular sieves are a commercially important class of materials that have distinct crystal structures with defined pore structures that are shown by distinct X-ray diffraction (XRD) patterns. The molecular sieves also have specific chemical compositions. The crystal structure defines cavities and pores that are characteristic of the specific type of molecular sieve. Providing new molecular sieves that offer differences in the crystal structure as well as the composition can lead to unique catalysts or adsorption/separation materials. Changing a crystal structure is always fraught with difficulties, but success can provide rewards in a new catalyst for organic compound conversion reactions. U.S. Pat. No. 6,849,248 discloses the preparation of ITQ-21. It does not, however, disclose a boron ITQ-21.

### SUMMARY

According to the present disclosure, a new crystalline germanosilicate molecular sieve, designated boron ITQ-21, is synthesized using an N,N-diethyl-5,8-dimethyl-2-azonium bicyclo [3.2.2] nonane cation as a structure directing agent (SDA). The synthesis has been found to be successful in providing a boron containing molecular sieve having the ITQ-21 crystal structure.

In a further aspect, there is provided a method of synthesizing the molecular sieve described herein, the method comprising (1) preparing a reaction mixture comprising: (a) a silicon source; (b) a source of germanium; (c) a source of boron; (d) a structure directing agent comprising an N,N-diethyl-5,8-dimethyl-2-azonium bicyclo [3.2.2] nonane cation (Q); (e) a source of fluoride ions; and (f) water; and (2) subjecting the reaction mixture to crystallization conditions sufficient to form crystals of the boron molecular sieve. The boron containing ITQ-21 molecular sieve is then treated to remove the SDA, which can be achieved by calcination or by ozone treatment.

In yet another aspect, there is provided a process of converting a feedstock comprising an organic compound to a conversion product which comprises contacting the feedstock at organic compound conversion conditions with a catalyst comprising the boron ITQ-21 molecular sieve described herein.

Among other factors, the present process allows one to obtain a boron ITQ-21 molecular sieve. This new molecular sieve prepared by the present process can offer unique abilities as a catalyst in organic compound conversion reactions. The molecular sieve also finds important value as an adsorption/separation material.

### BRIEF DESCRIPTION OF THE DRAWING

The FIGURE is a x-ray diffraction pattern of the calcined form of the present borongermanosilicate ITQ-21 molecular sieve.

### DETAILED DESCRIPTION

### Definitions

The term “framework type” has the meaning described in the “Atlas of Zeolite Framework Types” by Ch. Baerlocher, L. B. McCusker and D. H. Olson (Elsevier, Sixth Revised Edition, 2007).

The term “as-synthesized” is employed herein to refer to a molecular sieve in its form after crystallization, prior to removal of the structure directing agent.

The term “anhydrous” is employed herein to refer to a molecular sieve substantially devoid of both physically adsorbed and chemically adsorbed water.

As used herein, the numbering scheme for the Periodic Table Groups is as disclosed in Chem. Eng. News 1985, 63 (5), 26-27.

### Synthesis of the Boron Molecular Sieve

The present molecular sieve boron ITQ-21 can be synthesized by: (1) preparing a reaction mixture comprising (a) a source of silicon; (b) a source of germanium; (c) a source of boron; (d) a structure directing agent comprising an N,N-diethyl-5,8-dimethyl-2-azonium bicyclo [3.2.2] nonane cation (Q); (e) a source of fluoride ions; and (f) water; then (2) subjecting the reaction mixture to crystallization conditions sufficient to form crystals of the boron ITQ-21 molecular sieve. If aluminum is present, it is only present in a small amount. Thus, the framework contains a predominant amount of boron.

In one embodiment, the silicon source can comprise a FAU framework type zeolite. In another embodiment, the silicon source comprises no aluminum.

The reaction mixture can have a composition, in terms of molar ratios, within the ranges set forth in Table 1:

TABLE 1

| Reactants | Broadest | Secondary |
|---|---|---|
| (SiO₂ + GeO₂)/B₂O₃ | ≥10 | ≥15 |
| Q/(SiO₂ + GeO₂) | 0.10 to 1.00 | 0.20 to 0.70 |
| F/(SiO₂ + GeO₂) | 0.10 to 1.00 | 0.20 to 0.70 |
| H₂O/(SiO₂ + GeO₂) | 2 to 10 | 4 to 8 |
| SiO₂/GeO₂ | 4 to 12 | 6 to 10 |
| SiO₂/B₂O₃ | ≥10 | |
| SiO₂/Al₂O₃ | ≥300 | ∞ (no Al) |

wherein Q comprises an N,N-diethyl-5,8-dimethyl-2-azonium bicyclo [3.2.2] nonane cation. In one embodiment, the molar ratio of (SiO₂+GeO₂)/B₂O₃ is in the range of 15 to 20.

The source of silicon can comprise a FAU framework type zeolite. The FAU framework type zeolite can be an ammonium-form zeolite or a hydrogen-form zeolite and is a source of silica for the reaction. The FAU zeolite will generally have a SiO₂/Al₂O₃ molar ratio of at least 300 or more. Examples of the FAU framework type zeolite include zeolite Y (e.g., CBV720, CBV760, CBV780, HSZ-HUA385, and HSZ-HUA390). Zeolite Y can have a SiO₂/Al₂O₃ molar ratio of from 300 to 500. The FAU framework type zeolite can comprise two or more zeolites. The two or more zeolites can be Y zeolites having different silica-to-alumina molar ratios. The FAU framework type zeolite can be the sole or predominant source of silicon. In some aspects, a separate source of silicon may be added. Separate sources of silicon include colloidal silica, fumed silica, precipitated silica, alkali metal silicates and tetraalkyl orthosilicates. Sources of silicon with no aluminum can be quite useful. In one embodiment, the source of silicon comprises no Al.

Suitable sources of germanium include germanium oxide and germanium alkoxides (e.g., germanium ethoxide, germanium isopropoxide).

Silicon and germanium may be present in the reaction mixture in a SiO₂/GeO₂ molar ratio of from 4 to 12 (e.g., 6 to 10).

Suitable sources of boron can include boric acid, which is preferred.

Suitable sources of fluoride ions include hydrogen fluoride, ammonium fluoride and ammonium bifluoride.

The structure directing agent is an N,N-diethyl-5,8-dimethyl-2-azonium bicyclo [3.2.2] nonane cation having the following structure:

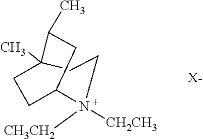

where X is an anion that is not detrimental to the formation of the boron ITQ-21. Representative anions include halogen, e.g., fluoride, chloride, bromide and iodide, hydroxide, acetate, sulfate, tetrafluoroborate, carboxylate, and the like. Hydroxide is the most preferred anion.

Suitable sources of Q are the hydroxides, chlorides, bromides, and/or other salts of the compound.

The reaction mixture can have a Q/F molar ratio in a range of from 0.80 to 1.20 (e.g., 0.85 to 1.15, 0.90 to 1.10, 0.95 to 1.05, or 1 to 1).

The reaction mixture can contain seeds of a molecular sieve material, such as boron ITQ-21 from a previous synthesis, in an amount of from 0.01 to 10,000 ppm by weight (e.g., 100 to 5000 ppm by weight) of the reaction mixture. Seeding can be advantageous in decreasing the amount of time necessary for complete crystallization to occur. In addition, seeding can lead to an increased purity of the product obtained by promoting the nucleation and/or formation of boron ITQ-21 over any undesired phases. While boron ITQ-21 seeds are preferred, in one embodiment, seeds of prior ITQ-21 zeolite made without boron can be used.

It is noted that the reaction mixture components can be supplied by more than one source. Also, two or more reaction components can be provided by one source. The reaction mixture can be prepared either batchwise or continuously.

### Crystallization and Post-Synthesis Treatment

Crystallization of the boron ITQ-21 molecular sieve from the above reaction mixture can be carried out under either static, tumbled or stirred conditions in a suitable reactor vessel (e.g., a polypropylene jar or a Teflon-lined or stainless-steel autoclave) at a temperature of from 100° C. to 200° C. (e.g., 150° C. to 175° C.) for a time sufficient for crystallization to occur at the temperature used (e.g., 1 day to 14 days, or 2 days to 10 days). The hydrothermal crystallization process is typically conducted under pressure, such as in an autoclave, and is preferably under autogenous pressure.

Once the molecular sieve crystals have formed, the solid product can be recovered from the reaction mixture by standard mechanical separation techniques such as centrifugation or filtration. The recovered crystals are water-washed and then dried to obtain the as-synthesized molecular sieve crystals. The drying step can be performed at an elevated temperature (e.g., 75° C. to 150° C.) for several hours (e.g., about 4 to 24 hours). The drying step can be performed under vacuum or at atmospheric pressure.

As a result of the crystallization process, the recovered crystalline molecular sieve product contains within its pore structure at least a portion of the structure directing agent used in the synthesis.

The as-synthesized molecular sieve may also be subjected to treatment to remove part or all of the structure directing agent used in its synthesis. This is conveniently affected by thermal treatment (i.e., calcination) in which the as-synthesized material is heated at a temperature of at least about 370° C. for at least 1 minute and generally not longer than 20 hours. While sub-atmospheric pressure can be employed for the thermal treatment, atmospheric pressure is desired for reasons of convenience. The thermal treatment can be performed at a temperature up to about 925° C. The thermal treatment may be carried out in an atmosphere selected from air, nitrogen or mixture thereof. For example, the thermal treatment may be conducted at a temperature of from 400° C. to 600° C. in air for a time period of from 3 to 8 hours. Alternatively, the structure directing agent Q can be removed by treatment with ozone. The ozone treatment may include heating the as-synthesized molecular sieve in the presence of ozone, such heating may be at a temperature of from 50° C. to 350° C. (e.g., from 100° C. to 300° C., or from 125° C. to 250° C.).

### Characterization of the Molecular Sieve

In its as-synthesized and anhydrous form, molecular sieve ITQ-21 with boron can have a chemical composition comprising the following molar relationship set forth in Table 2:

TABLE 2

| | Broadest | Secondary |
|---|---|---|
| (SiO₂ + GeO₂)/B₂O₃ | ≥10 | ≥15 |
| Q/(SiO₂ + GeO₂) | >0 to 0.1 | >0 to 0.1 |
| Q/SiO₂ | ≤0.1 | ≤0.05 |
| SiO₂/GeO₂ | 4 to 12 | 6 to 10 |
| SiO₂/Al₂O₃ | ≥300 | ∞ (no Al) |

wherein Q comprises an N,N-diethyl-5,8-dimethyl-2-azonium bicyclo [3.2.2] nonane cation.

Thus, the composition can be said to comprise the molar relationship of B₂O₃:(n)(SiO₂) with n≥10 in one embodiment, n≥15 in another embodiment, and n ranging from about 15 to 20 in one embodiment.

The molecular sieve boron ITQ-21 has a powder x-ray diffraction (XRD) pattern which, in the as-synthesized form of the molecular sieve, includes at least the peaks listed in Table 3 below. In the calcined form of the molecular sieve, the XRD pattern, shown in the FIGURE, includes at least the peaks listed in Table 4 below.

TABLE 3
Characteristic XRD Peaks for As-Synthesized Boron ITQ-21

| d(±0.3 Å) | Relative Intensity |
|---|---|
| 13.77 | m |
| 7.96 | m |
| 4.88 | m |
| 4.60 | s |
| 4.16 | m |
| 3.45 | s |

TABLE 4
Characteristic XRD Peaks for Calcined Boron ITQ-21

| d(±0.3 Å) | Relative Intensity |
|---|---|
| 13.64 | vs |
| 7.87 | vs |
| 4.82 | w |
| 4.55 | m |
| 4.11 | m |
| 3.41 | m |

These diffractograms were obtained with a Philips X Pert diffractometer equipped with a graphite monochromator and an automatic divergence slit using Kα radiation from copper. The diffraction data was recorded by means of a 2 θ pass of 0.01° wherein θ is the Bragg angle and a count time of 10 seconds per pass. The interplanar spaces d were calculated in Ångstrom and the relative intensity of the lines is calculated as a percentage with respect to the most intense peak, and is designated as very strong (vs)=80-100, strong(s)=60-80, medium (m)=40-60, weak (w)=20-40 or very weak (vw)=0-20.

Minor variations in the diffraction pattern can result from variations in the mole ratios of the framework species of the sample due to changes in lattice constants. In addition, disordered materials and/or sufficiently small crystals will affect the shape and intensity of peaks, leading to significant peak broadening. Minor variations in the diffraction pattern can also result from variations in the organic compound used in the preparation. Calcination can also cause minor shifts in the XRD pattern. Notwithstanding these minor perturbations, the basic crystal lattice structure remains unchanged.

### INDUSTRIAL APPLICABILITY

Molecular sieve boron ITQ-21 (where part or all of the structure directing agent is removed) may be used as a sorbent or as a catalyst to catalyze a wide variety of organic compound conversion processes. Of particular applicability is use of the boron ITQ-21 in reforming processes.

Catalytic reforming is one of the basic petroleum refining processes for upgrading light hydrocarbon feedstocks, frequently referred to as naphtha feedstocks. Products from catalytic reforming can include high octane gasoline useful as automobile fuel, aromatics (for example benzene, toluene, xylenes and ethylbenzene), and/or hydrogen. Reactions typically involved in catalytic reforming include dehydrocylization, isomerization and dehydrogenation of naphtha range hydrocarbons, with dehydrocyclization and dehydrogenation of linear and slightly branched alkanes and dehydrogenation of cycloparaffins leading to the production of aromatics. Dealkylation and hydrocracking are generally undesirable due to the low value of the resulting light hydrocarbon products.

The boron ITQ-21 catalyst used in reforming reactions would often include a Group VIII metal, such as platinum or palladium, or a Group VIII metal plus a second catalytic metal, which acts as a promoter. Examples of metals useful as promoters include rhenium, tin, tungsten, germanium, cobalt, nickel, rhodium, ruthenium, iridium or combinations thereof. The catalytic metal or metals may be dispersed on a support such as alumina, silica, or silica-alumina.

The boron ITQ-21 reforming catalyst may be employed in the form of pills, pellets, granules, broken fragments, or various special shapes, disposed as a fixed bed within a reaction zone, and the charging stock may be passed through in the liquid, vapor, or mixed phase, and in either upward, downward or radial flow. Alternatively, the reforming catalysts can be used in moving beds or in fluidized-solid processes, in which the charging stock is passed upward through a turbulent bed of finely divided catalyst. However, a fixed bed system or a dense-phase moving bed system are preferred due to less catalyst attrition and other operational advantages. In a fixed bed system, the feed is preheated (by any suitable heating means) to the desired reaction temperature and then passed into a reaction zone containing a fixed bed of the catalyst. This reaction zone may be one or more separate reactors with suitable means to maintain the desired temperature at the reactor entrance. The temperature must be maintained because reforming reactions are typically endothermic in nature.

The actual reforming conditions often depend, at least in part, on the feed used, whether highly aromatic, paraffinic or naphthenic and upon the desired octane rating of the product and the desired hydrogen production.

### EXAMPLES

The following illustrative examples are intended to be non-limiting.

### Example 1

Synthesis of N,N-diethyl-5,8-dimethyl-2-azonium bicyclo [3.2.2]nonane Cation

A three-neck, 5-liter flask is set up with additional funnel with equalization arm. A septum is place over the funnel. Nitrogen is passed through the system. First an in-situ reagent is developed by placing 104.55 grams of diisopropylamine in 1859 ml of tetrahydrofuran (THF) and then slowly adding 401.7 ml of n-butyl lithium (2.5 M in hexane) while keeping the temperature near −70° C. The n-butyl lithium is charged to the addition funnel by use of a cannula. The addition into THE takes about 1.25 hours after which the resulting mixture is stirred for another hour. 104.53 grams of 3-methyl-2-cyclohexene-1 one in 1117 ml THF is added dropwise over a 0.75 hour period. Lastly, 161.73 grams of methyl acrylate is added over a period of 0.25 hour. Gradually, the reaction is allowed to warm to room temperature and its progress is followed by TLC. The reaction appears to go overnight.

Recovery of the product is begun by adding 1N HCl until the solution becomes acidic. The reaction product is transferred to separatory funnel and the aqueous phase is recovered to subsequently treat with methylene chloride (2×250 ml). The combined organic phase is dried over sodium sulfate and then strip solvent. The residue is taken up in ether to free it from a little gummy material. The ether is removed and the resulting oil is distilled; a Vigreaux column (30 cm) is set up and run at 2-4 mm Hg. The bulk of the product comes over between 123-137° C.

The resulting product is reduced using lithium aluminum hydride. The reduction produces a diol, 1-methyl-2-methanol-7-hydroxy bicyclo [2.2.2] octane. The side methanol group is tosylated by reaction of tosyl chloride (96.92 grams) with the diol (85.68 grams) in anhydrous pyridine (500 ml). The tosyl chloride is added to the other two components, under nitrogen, using a powder addition funnel while cooling the reaction to −5° C. The addition is carried out over 0.75 hour and the reaction mixture is warmed to room temperature and the reaction is allowed to run overnight. 500 ml of methylene chloride is added, the resulting mixture transferred to a separatory funnel, and washed with water (2×250 ml). The resulting product is dried over sodium sulfate, filtered, and stripped to yield 150grams of oil.

The product is purified by column chromatography. A kilogram of silica gel (230-400 mesh) is slurried in hexane, and the oil is loaded on top in 50 ml methylene chloride. The elution is carried out using 25/75 ethyl acetate (ETOAC); hexane and fractions are monitored by TLC. Eighty-three grams of product is collected. The tosylate is then reduced using LAH (as above) to yield 1,2-dimethyl-7-hydroxy bicyclo [2.2.2] octane. Next, the alcohol is reoxidized to the ketone. 37.84 grams of the alcohol is reacted in a three-neck, 2-liter flask as follows: 34.60 grams of oxalyl chloride and 604 ml of methylene chloride are loaded in and blanketed under nitrogen. With an addition funnel with side arm, 46 grams of anhydrous dimethylsulfoxide (DMSO) in 122.7 ml of methylene chloride is added. The bath is cooled to −60° C. using a dry ice/acetone bath, and the addition takes 0.5 hour. The alcohol, in 53.4 ml methylene chloride, is added at this temperature over 0.5 hour followed by stirring for another 0.5 hour. 126.65 Grams of tricthylamine is then placed in the addition funnel and addition begun and continued over 0.25 hour. All of the additions produce exothermic response, so cooling is continued. The reaction mixture is slowly warmed to room temperature and the reaction continued to run overnight.

Work-up of the reaction product begins with addition of 500 ml water. The separated aqueous phase is then extracted with methylene chloride (2×250 ml). The combined organic phases are then dried over magnesium sulfate and stripped. The resulting oil is triturated with ether to separate a small amount of insoluble material. Stripping off ether yields 37 grams of product.

Thirty-seven grams of ketone and 240 ml of 96% formic acid are placed into a 1 liter round bottom flask connected to an addition funnel. These components are stirred using a magnetic stir bar. 125 Ml of formic acid with 43 grams of hydroxylamine-O-sulfonic acid dissolved and suspended in it, are added to the funnel. The addition is carried out over a 20 minute period with stirring. The solution darkens. The addition funnel is replaced with a reflux condenser, and the reaction is refluxed for 15-20 hours with samples taken to follow by TLC.

The mixture is carefully poured into 2 kg of ice. After cooling in the ice, the mixture is slowly brought to pH=12 with the addition of 50% NaOH. Three extractions are carried out using 500 cc units of methylene chloride. These extracts are dried over sodium sulfate. After drying, the solvent is stripped off leaving a black oil of about 45 grams.

This oil is dissolved in a minimum of chloroform and loaded onto a column (750 grams of 230-400 mesh silica gel, already slurried in chloroform). The elution progresses using chloroform with 2 vol. % methanol. The elution fractions are followed by TLC (fractions 7-21 give the same product). The similar fractions are combined and removing the eluting solvent yields about 30 grams of lactam.

25 Grams of this lactam is used in the reduction step. Using a 2 liter 3-neck round bottom flask, nitrogen gas is run into the system and vented up through the reflux condenser and into a bubbler. The system has an addition funnel. 460 Ml of anhydrous ether are added into the flask. Carefully, 18 grams of lithium aluminum hydride are also admitted into the flask. There is some gas evolution. The lactam is dissolved in 230 ml of methylene chloride (also anhydrous). After cooling the flask down in an acetone/dry ice bath, the lactam is added dropwise. The reaction is exothermic so periodically more ice needs to be added as temperature rises. The reduction can be followed by change in TLC data (monitored by iodine and eluted on silica with 98/2 chloroform/methanol). The reaction is allowed to come to room temperature overnight.

18 Grams of water are slowly added with the expected exothermic evolution of gas occurring. The ether is removed and its volume replaced with dichloromethane. 18 Grams of 15% NaOH solution and then 55 grams of water are added. The solids which form are filtered off, washed with additional dichloromethane, and combined with the organic fractions and dry over sodium sulfate (Caution: Do not let the NaOH solution sit in contact with dichloromethane overnight.). The solvent is stripped off to recover about 15 grams of oil/solid mix. This is the crude amine.

10 grams of this amine is quaternized as follows: In a 250 ml flask equipped with stir bar and reflux condenser add the amine, 10 grams of KHCO₃, 65 ml of methanol and lastly, 30 grams of ethyl iodide. The mixture is brought to reflux and maintained in that state for 48 hours. Upon cooling, the solvent is removed. The solids are treated with chloroform. In turn the chloroform-soluble fractions are stripped to yield another solid which is recrystallized from a minimum of hot acetone and methanol. Recrystallization in the cold yields 3 separate crops of product, totaling 11 grams of the salt. The melting points for these crops are all in the range of 252-256° C.

The salt is converted to the hydroxide form by ion-exchange over a BioRad AG1-X8 resin.

### Example 2

### Synthesis of ITQ-21 Boron

0.32 g of GeO₂ and 0.085 grams of boric acid are dissolved in 11.25 g of N,N-diethyl-5,8-dimethyl-2-azonium bicyclo [3.2.2] nonane hydroxide solution with a concentration of 1.48 mol/kg. In the solution obtained, 6.30 g of tetraethylorthosilicate are hydrolysed and stirring is maintained allowing all the ethanol formed in the hydrolysis to evaporate. 0.69 g are then added of a hydrofluoric acid solution (48.1% of HF by weight) and evaporation is continued.

The gel is heated at 160° C. whilst stirring for 5 days in a steel autoclave with an internal Teflon lining. The solid obtained after filtering, washing with distilled water, and drying at 100° C., is Boron ITQ-21. It exhibits the list of diffraction peaks in Table 3.

### Example 3

While one can calcine the boron ITQ-21, it is preferred to first treat the zeolite with ozone at 150° C. to remove the SDA guest molecule. In addition, it was also found that much of the SDA could be first removed by a treatment with dimethylformide in a closed reactor at 150° C.; 1 grams of as-made zeolite and 7ml dimethylformamide, heated static for 3-5 days.

The as-made boron ITQ-21 is loaded into a cell to then have ozone passed through it while heated to 150° C. The treatment is carried out for 16-20 hours. The mass loss (if not treated by dimethylformamide) is roughly 40%.

The XRD pattern is essentially the same as the calcined XRD pattern described previously.

### Example 4

### Platinum Addition

The borogermano ITQ-21 zeolite, after treatment with first dimethylformamide and the ozone to remove the organic, is neutralized with Cesium hydroxide (50%), 0.11 gram in 10 ml of water. The solution is stirred at room temperature for 24 hours. The zeolite is then filtered off, dried, and calcined to 300° C. Then 0.68 grams of the exchanged zeolite is treated in 16 grams of water with 0.013 grams of Platinum from platinum tetraamine chloride hydrate. The solution is stirred at room temperature for 24 hours, filtered, dried and calcined to 300° C. (3 hours at highest temperature). The solids are then pressed, meshed (24/40 chips) and loaded into a reactor for testing.

### Example 5

### Pretreatment of Catalytic Naphtha Reforming Catalyst

The catalytic naphtha reforming catalyst prepared in Example 4 was sulfided. The sulfiding reactions were conducted in down flow fixed bed reactor systems. The procedure is described as follows:

The catalyst was meshed to 24-40 chips and then loaded into the center of a stainless steel tube reactor. The catalyst (0.53 g dry weight as determined at 1112° F. by TGA (Thermogravimetric Analysis)) was first dried in a N₂ flow (300 ml/min) from room temperature to 400° F. at a heating rate of 10° F./min and kept at 400° F. for 30 minutes. For the reduction of the platinum in the catalyst, the catalyst was subsequently heated in a H₂ flow (300 ml/min) from 400° F. to 900° F. at a heating rate of 5° F./min and kept at 900° F. for 30 minutes. Finally, the catalyst was cooled down to 800° F. to start the sulfiding reactions.

The feed applied for sulfiding reactions was anhydrous n-octane containing 200 ppm sulfur (as dimethyl disulfide). The sulfiding was carried out at 800° F. and atmospheric pressure for 60 minutes. The H₂ and liquid feed flow rates were 30 ml/min and 0.43 ml/min, respectively. After sulfiding, the catalyst was heated in a H₂ flow (300 ml/min) from 800° F. to 900° F. within minutes and then at 900° F. for another 30 minutes in order to remove the excess sulfur species occluded in the pores and/or on the surface of the catalyst. Finally, the catalyst was heated up or cooled down to the preset reaction temperature (e.g., 850° F. or 950° F.) within 2 hours in the same H₂ flow (300 ml/min) to be ready for starting the catalytic naphtha reforming testing in Example 6.

### Example 6

### Procedure of Catalytic Naphtha Reforming Testing

After the sulfiding procedure described in Example 5, the catalytic naphtha reforming reactions were conducted as described below.

The catalyst was heated up or cooled down to the preset reaction temperature (950° F. for Example 8) within 2 hours in the same H₂ flow (300 ml/min) to be ready for starting the catalytic naphtha reforming testing in the present example, as described in Example 5. At the same time, the reactor system was pressurized to the preset pressure (150 psig for Example 8). Meanwhile, the H₂ flow was adjusted to the preset rate (14 ml/min for Example 8). The feed rate was 1.55 ml/hour (for Example 8).

In the following example, the catalytic naphtha reforming experiment was carried out at hydrocarbon WHSV of 2.2 and molar ratio of hydrogen to hydrocarbon of 3.0 by using the naphtha feed described in Example 7.

### Example 7

### Feed for Catalytic Naphtha Reforming Testing

The GC analytical data from the feed used for the catalytic naphtha reforming testing in the present invention are given in Table 5 below, together with the GC results from Example 8 for its catalytic naphtha reforming testing product over the catalyst described in Example 5. The GC data were acquired via on-line analysis.

### Example 8

Product from Catalytic Naphtha Reforming Testing

The GC analytical data from the feed of Example 7, used in the catalytic naphtha reforming testing, are given in Table 5 below, together with the results from the present example for its catalytic naphtha reforming testing product over the catalyst described in Example 5. The catalytic naphtha reforming experiment was carried out at 950° F., 150 psig, hydrocarbon WHSV of 2.2 and molar ratio of hydrogen to hydrocarbon of 3.0.

TABLE 5

| | Feed | Product |
|---|---|---|
| Component, in wt. % | (Example 7) | (Example 8) |
| Methane | 0 | 0.2 |
| ethane | 0 | 0.8 |
| propane | 0 | 1.0 |
| iso-butane | 0 | 0.2 |
| n-butane | 0 | 0.3 |
| iso-pentane | 0 | 0.1 |
| n-pentane | 0 | 0.2 |
| cyclopentane | 0 | 0.1 |
| iso-hexanes | 0.5 | 0.8 |
| n-hexane | 1.5 | 2.6 |
| C6 naphthenes | 2.5 | 3.0 |
| benzene | 0 | 1.8 |
| iso-heptanes | 1.2 | 11.4 |
| n-heptane | 7.2 | 10.8 |
| C7 naphthenes | 4.7 | 12.8 |
| toluene | 5.6 | 8.8 |
| iso-octanes | 31.3 | 15.9 |
| n-octane | 13.1 | 8.9 |
| C8 naphthenes | 4.3 | 4.5 |
| ethylbenzene | 1.4 | 2.5 |
| xylenes | 5.7 | 8.0 |
| heavier paraffins and naphthenes | 20.1 | 4.3 |
| heavier aromatics | 0.9 | 1.0 |

The product in Table 5 shows an increase in aromatics and octane gasoline. The boron ITQ-21 successfully reformed the feedstock of Example 7.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

1. A molecular sieve having a powder X-ray diffraction pattern in its as-synthesized form with at least the following diffraction lines:

| d(±0.3 Å) | Relative Intensity |
|---|---|
| 13.77 | m |
| 7.96 | m |
| 4.88 | m |
| 4.60 | s |
| 4.16 | m |
| 3.45 | s |

and comprising boron in the framework.

2. The molecular sieve of claim 1, and having a composition comprising the molar relationship:
B₂O₃:(n)(SiO₂+GeO₂),
wherein n is ≥10.

3. The molecular sieve of claim 1, and having a composition comprising the molar relationship:
B₂O₃:(n)(SiO₂+GeO₂),
wherein n is ≥15.

4. The molecular sieve of claim 2, wherein n ranges from about 15 to 20.

5. The molecular sieve of claim 1, wherein the SiO₂/GeO₂ molar ratio ranges from 4 to 12.

6. The molecular sieve of claim 1, wherein the SiO₂/GeO₂ molar ratio ranges from 6 to 10.

7. The molecular sieve of claim 1, wherein the SiO₂/Al₂O₃ molar ratio is ≥300.

8. The molecular sieve of claim 1, wherein the SiO₂/Al₂O₃ molar ratio is ∞ (no Al).

9. A molecular sieve having, in its calcined form at least the following diffraction lines:

| d(±0.3 Å) | Relative Intensity |
|---|---|
| 13.64 | vs |
| 7.87 | vs |
| 4.82 | w |
| 4.55 | m |
| 4.11 | m |
| 3.41 | m |

and with the molecular sieve comprising boron in the framework.

10. The molecular sieve of claim 9, having a chemical composition comprising the following molar relationships:

| | |
|---|---|
| (SiO₂ + GeO₂)/B₂O₃ | ≥10 |
| Q/(SiO₂ + GeO₂) | >0 to 0.1 |
| SiO₂/GeO₂ | 6 to 10 |
| SiO₂/Al₂O₃ | ∞ (no Al) |

wherein Q comprises an N,N-diethyl-5,8-dimethyl-2-azonium bicyclo [3.2.2] nonane cation.

11. The molecular sieve of claim 10, wherein the molar ratio of (SiO₂/GeO₂)/B₂O₃ ranges from about 15 to 20.

12. A method of synthesizing the molecular sieve of claim 4, the method comprising:
(1) preparing a reaction mixture comprising:
(a) a silicon source;
(b) a source of germanium;
(c) a source of boron;
(d) a structure directing agent comprising an N,N-diethyl-5,8-dimethyl-2-azonium bicyclo [3.2.2] nonane cation;
(e) a source of fluoride ions; and
(f) water; and
(2) subjecting the reaction mixture to crystallization conditions sufficient to form crystals of the molecular sieve.

13. The method of claim 12, wherein the silicon source comprises a FAU framework type zeolite having a SiO₂/Al₂O₃ molar ratio of 300 or greater.

14. The method of claim 12, wherein the silicon source comprises no Al.

15. The method of claim 12, wherein the reaction mixture has a composition, in terms of molar ratios, as follows:

| | |
|---|---|
| (SiO₂ + GeO₂)/B₂O₃ | ≥10 |
| Q/(SiO₂ + GeO₂) | 0.10 to 1.00 |
| F/(SiO₂ + GeO₂) | 0.10 to 1.00 |
| H₂O/(SiO₂ + GeO₂) | 2 to 10. |
| SiO₂/GeO₂ | 4 to 12 |
| SiO₂/B₂O₃ | ≥10 |
| SiO₂/Al₂O₃ | ≥300. |

16. The method of claim 12, wherein the reaction mixture has a composition, in terms of molar ratios, as follows:

| | |
|---|---|
| (SiO₂ + GeO₂)/B₂O₃ | ≥15 |
| Q/(SiO₂ + GeO₂) | 0.20 to 0.70 |
| F/(SiO₂ + GeO₂) | 0.20 to 0.70 |
| H₂O/(SiO₂ + GeO₂) | 4 to 8 |
| SiO₂/GeO₂ | 6 to 10 |
| SiO₂/Al₂O₃ | ∞ (no Al). |

17. The method of claim 15, wherein the molar ratio of (SiO₂+GeO₂)/B₂O₃ is in the range of about 15 to 20.

18. The method of claim 12, wherein the crystallization conditions include a temperature of from 100° C. to 200° C.

19. The method of claim 12, wherein the reaction mixture has a molar ratio of Q/F in a range of from 0.8 to 1.2.

20. A process for converting a feedstock comprising an organic compound to a conversion product, the process comprising contacting the feedstock at organic compound conversion conditions with a catalyst comprising the molecular sieve of claim 8.

21. The process of claim 20, wherein the reaction is a reforming reaction and the catalyst comprises platinum.

22. A molecular sieve prepared by the process of claim 12.

23. A molecular sieve prepared by the process of claim 14.
